(19) United States
(12) Patent Application Publication
(10) Pub. No.: US 2014/0123159 A1
(43) Pub. Date: May 1, 2014

(54) Providing Content On Demand

(71) Applicant: TELEFONAKTIEBOLAGET L M ERRICSSON (PUBL), (US)

(72) Inventors: Chris Phillips, Hartwell, GA (US); Robert Hammond Forsman, Sugar Hill, GA (US); Jennifer Ann Reynolds, Sugar Hill, GA (US); Charles Hammett Dasher, Lawrenceville, GA (US)

(73) Assignee: TELEFONAKTIEBOLAGET L M ERICSSON (PUBL), Stockholm (SE)

(21) Appl. No.: 13/665,272

(22) Filed: Oct. 31, 2012

(51) Int. Cl. H04N 21/25

(52) U.S. Cl. 725/1

(57) ABSTRACT

A method of providing content on demand is provided. Content corresponding to multiple video assets having multiple content owners is received. Content metadata definitions that are associated with the video assets is received. The content metadata definitions including billing data corresponding to an access fee for accessing ones of the video assets. The video assets are encrypted and the encrypted video assets are published. Metadata corresponding to each of the video assets is published. The metadata includes payment delivery data corresponding to the access fee for accessing respective ones of the video assets.

### TECHNICAL FIELD

The present disclosure is directed to content on demand and, more particularly to systems and methods of providing content on demand

### BACKGROUND

Video On Demand (VOD) systems allow users to purchase and consume multimedia content within their own Multiple System Operator (MSO)/cable system. This content is played out through a Set Top Box (STB) and television (TV) within the user's premises. Video content and the consumption thereof have become increasingly democratic and social experiences with the advent of video aggregators such as YouTube. However, traditional video providers may face challenges in monetizing and/or managing new forms and trends in video consumption.

For example, content delivered without traditional content provider control or distribution may be referred to as over the top content (OTT). Consumers may access OTT content using Internet-connected devices such as personal computers (PCs), laptops, tablets, smartphones, smart TV devices, and/or gaining consoles among others. A provider may be aware of the contents of the IP packets being transmitted, but may have no responsibility or control over the viewing abilities, intellectual property rights, or other redistribution of the OTT content. However, there may be no mechanism for a consumer to access OTT content via a managed network using a cable system.

Additionally, the quality of available online video is increasing as independent (“indie”) video content creators gain increased traction. For example, video is consumed in a variety of formats including traditional cable (e.g., set top boxes), various adaptive streaming formats and/or through progressive download formats. Payment for video content has typically been processed either by a video provider (e.g., cable company or iTunes) or by the video content creator. Independent content creators may rely on direct payments from consumers rather than attempting to “break into” business with the video providers. This may restrict video providers from a valuable source of potential income, however. Also, consumer access to content may be limited under current content delivery schemes. For example, consumers may have to choose between video provider curated content or sifting through unorganized video collections, such as may be found via the Internet, to find desirable content.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

It is therefore an object to address at least some of the above mentioned disadvantages and/or to improve performance in content delivery.

One or more of the above described problems may be overcome by methods of providing content on demand. Such methods may include generating catalog content of video assets that includes delivery metadata associated with the video assets and that is published by multiple content providers, the delivery metadata including location information corresponding to a storage location of each of the video assets and billing data that is associated with each of the video assets and that is specific to a respective one of the content providers. A request made by a user to access one of the video assets may be received and the end user may be provided access to a requested video asset.

Embodiments described herein may increase the rate at which video assets are published and distributed by generating the catalog content including the delivery metadata. For example, any content provider that publishes an asset with compatible metadata can be included in VOD menus. As such, available VOD content may be expanded to users, thus increasing revenue opportunities to service providers. In some embodiments, the menus are selected by the user which provides a filtering effect regarding content that matches the user's viewing tastes.

Some embodiments include receiving the location information and the billing data corresponding to each of the video assets from an associated one of the content providers. In some embodiments, receiving the location information and/or the billing data includes fetching the location information and/or content metadata definition from a published source corresponding to at least one of the plurality of content providers.

In some embodiments, the billing data includes a billing amount and payment processing data corresponding to each of the video assets. Some embodiments provide that the payment processing data includes a payment recipient identity and/or a payment method data.

Some embodiments include receiving decryption data corresponding to encrypted ones of the video assets from ones of the content providers. The decryption data may include a link to a network location that includes a decryption key corresponding to one of video assets. The delivery metadata may include the decryption data that corresponds to encrypted ones of the video assets.

Some embodiments include verifying that payment for the video asset is received corresponding to the billing data and transmitting the location information and content decryption data to a content management system that is operable to transcode content on demand for delivery to the user in response to receiving the request made by a user to access one of the video assets and before providing the end user access to the requested video asset. In some embodiments, verifying that the payment for the video asset is received includes determining that the user is subscribed to a content plan that provides access to the requested video asset.

Some embodiments provide that the video assets include over the top content and that providing the end user access to the requested video asset includes providing the delivery metadata corresponding to the requested video asset to the user to access and providing decryption data corresponding to the requested video asset.

In some embodiments, the catalog content of video assets is delivered to an end user by a service provider that includes at least one of a cable based content provider, an internet television service provider or an over the top content provider.

In some embodiments, the end user is a first user and the request to receive access one of the video assets includes receiving the request from a second user that received the delivery metadata from the first user. Some embodiments provide that providing the end user access to the requested video asset includes providing the second user access to the requested video asset. In response to receiving the request made by the second user to access one of the video assets and before providing the second user access to the requested video asset, receipt of payment for the video asset may be verified.

Some embodiments of the present disclosure include methods directed to providing content on demand. Operations corresponding to such methods may include receiving content corresponding to multiple video assets having multiple content owners and receiving content metadata definitions that are associated with the video assets. The content metadata definitions may include billing data corresponding to an access fee for accessing ones of the video assets.

The video assets may be encrypted and the encrypted video assets may be published. Metadata corresponding to each of the video assets may be published. The metadata may include payment delivery data corresponding to the access fee for accessing respective ones of the video assets.

Some embodiments include receiving, based on the payment delivery data, payment for the access fee from a user requesting to access one of the video assets and transmitting a decryption key that is operable to decrypt the one of the video assets to the user responsive to receiving payment from the user. Some embodiments further include sending at least a portion of the access fee to one of the content owners corresponding to receiving the payment from the user.

Some embodiments include verifying that a user requesting to access one of the video assets is a subscriber of a content plan that includes access to the one of the plurality of video assets and transmitting a decryption key that is operable to decrypt the one of the video assets to the user responsive to verifying that the user is the subscriber.

Some embodiments of the present disclosure are directed to a computer implemented system for providing content on demand. Some embodiments of the system include a content management module that is operable to receive menu fetch locations corresponding to video assets published by content providers and content metadata that includes billing data corresponding to the video assets and to generate catalog data including the menu fetch locations and/or the content metadata. The system may include an access management module that is operable to receive decryption data corresponding to the video assets and to determine content purchase data from the content metadata received by the content management module.

In some embodiments, the content management module is further operable to transmit content fetch location data to a content management system and the access management module is further operable to verify content purchase data and to provide the content management system access to decryption data corresponding to a requested video asset. In some embodiments, the content management system is operable to retrieve the video content from a location corresponding to the content fetch location data and to transcode the requested video asset using the decryption data from the access management module.

Other devices, nodes, systems and methods according to embodiments of the invention will be or become apparent to one with skill in the art upon review of the following drawings and detailed description.

It is intended that all such devices, modules, systems, nodes, and methods be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention.

FIG. 1 is a block diagram of a network including a system for providing content on demand according to some embodiments of the present invention.

FIG. 2 is a block diagram of a network illustrating operations corresponding to the delivery of content on demand according to some embodiments of the present invention.

FIGS. 3-11 are flow charts of operations and methods that can be performed to provide content on demand according to some embodiments of the present invention.

FIG. 12 is a block diagram of a network node user device configured according to some embodiments of the present invention.

### DETAILED DESCRIPTION

The invention will now be described more fully hereinafter with reference to the accompanying drawings, in which examples of embodiments of the invention are shown. This invention may, however, be embodied in many different forms and should not be construed as limited to the embodiments set forth herein. It should also be noted that these embodiments are not mutually exclusive. Components from one embodiment may be tacitly assumed to be present/used in another embodiment.

For purposes of illustration and explanation only, various embodiments of the present invention are described herein in the context of providing video content on demand. It will be understood, however, that the present invention is not limited to such embodiments and may be embodied generally to deliver other types on content in an on-demand provision or otherwise. For example, techniques herein may be applicable to content or services such as video, applications, games, audio, and/or ring tones, among others.

As discussed above, it is desirable to provide methods and/or systems un which individually created content may be made accessible to consumers. Additionally, it may be desirable for service and/or content providers to be able to provide content from non-traditional sources to provide further revenue sources and/or opportunities.

As disclosed herein, a system is provided in which content providers may publish metadata that includes references to their content and information corresponding to amounts and methods of payment for access to the content. The published metadata sets may be aggregated by a content clearing house, sanitized and/or organized. In some embodiments, aggregation may be performed through web crawls, direct upload from content creators and/or published content from over-the top content (OTT) providers. Sanitizing the content may include verifying proper content ratings and/or proper menu or chapter functions, where applicable. Once sanitized, the content and metadata may be available directly to consumers through traditional interfaces. For example, in the context of video-on-demand (VOD), the content and metadata may be available through set-top boxes.

Content clearing houses may charge a fee for each access of the available content. Additionally, consumers may be charged the amount that is specified in the menu metadata for the content. An operator billing system may interact with the content clearing house that may be provided in the operator's headend, and may manage payments to the OTT providers based on the operator agreements. For example, some embodiments provide that an operator may retain a percentage of the revenue of the purchased content. In this manner, consumers may enjoy increased access to a greater amount of content without having to learn new technologies by accessing the content through familiar interfaces. Additionally, video content creators may enjoy greater exposure to potential audiences.

Additionally, in contrast with OTT delivery over an unmanaged network, the content may be retrieved from an operator's direct connection to the Internet to provide content delivery over the managed network. In this manner, the content quality may be improved over traditional OTT delivery.

Yet further, embodiments as disclosed herein may provide an increased revenue model for service operators including, for example, cable television and/or internet protocol (IPTV) television operators. For example, a video catalog may be expanded to off OTT video content to be purchased and watched through the operator's video head-end system. Additionally, the head-end system may include a billing and payment system allowing both the operator and the OTT provider to receive payment. For example, the operator may receive a percentage of the payment received by the OTT provider for the purchased video content.

In some embodiments, an OTT provider may benefit by an increased customer base which may generate new and/or improved revenue streams. Additionally, a consumer and/or end user may benefit from an increase in options available for video content.

Although the description below focuses, for purposes of illustration, on embodiments in which the described techniques are utilized with respect to providing video-on-demand (VOD) content, the described techniques may be applied with respect to any type of media content that may not be typically available through service or content providers. As used herein, a user device may include wired or wireless communication terminals, such as desktop computers, laptop computers, cellular telephones, smart phones, electronic book readers, tablets, game consoles, set-top boxes, smart televisions, or any other devices that may have different processing, connectivity or user interface capabilities, and may include various types of tangible, computer-readable media. Each of the user devices may be associated with or otherwise accessible to, one or more users, to access a network using a wireless and/or wired connection. It will also be understood that a given user may own one or more devices of various configurations, or may use a device that is owned or controlled by another entity. Moreover, a given user may be a human user or an autonomous program, often referred to as a “robot”.

As used herein, when the term “user” or “end user” is used in the context of receiving, transmitting and/or performing any operation, the receiving, transmitting and/or other operation may be performed using a device, equipment, terminal and/or system that is owned, designated, used by, used for and/or allocated to the user and/or end user. For example, when a user is described as receiving content, such recitation may be read as user equipment receiving the content.

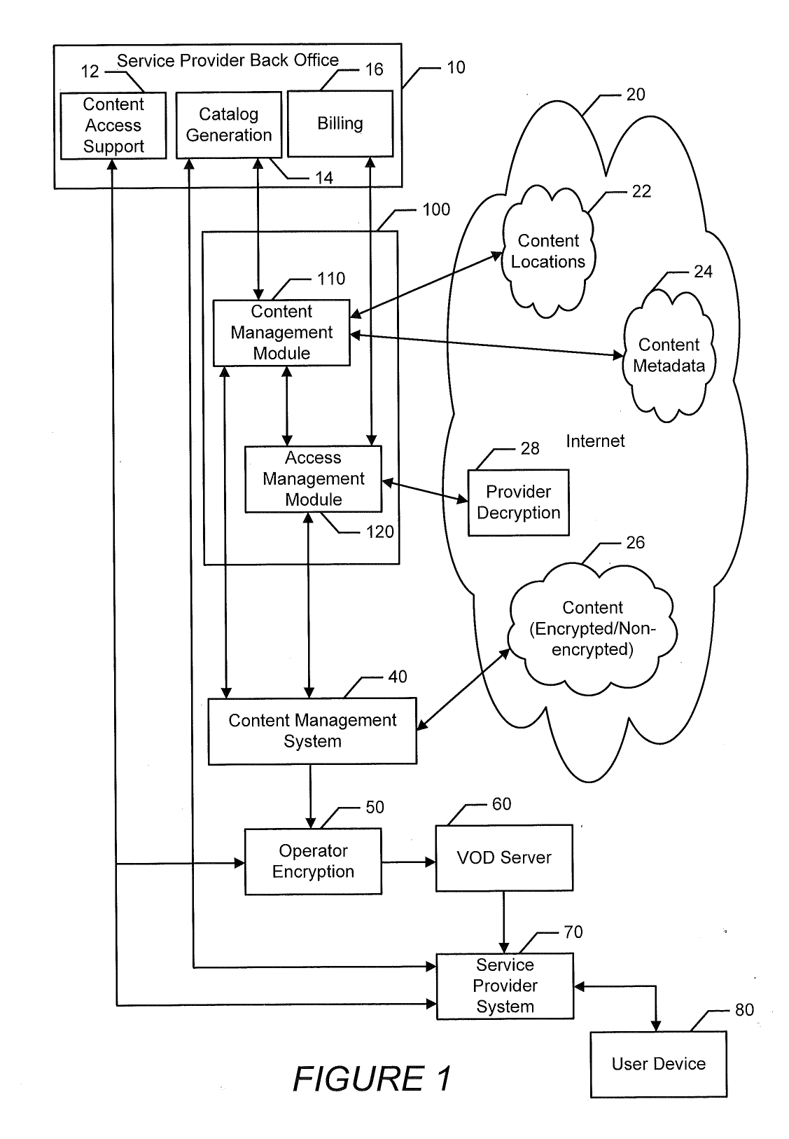

Reference is now made to FIG. 1, which is a block diagram of network devices, nodes, modules and/or operations corresponding to systems, methods and/or devices for providing content on demand according to some embodiments of the present invention. In some embodiments, a content enhancement module 100 is provided. For example, according to some embodiments, the systems, functions and/or operations disclosed herein may be implemented as features in a cable provider and/or Internet Protocol television (IPTV) provider back office.

The content enhancement module 100 may include a content management module 110 that is operable to receive content locations 22 corresponding to video assets published by content providers. In some embodiments, the content locations may include menu fetch locations corresponding to the video assets. Additionally, the content management module may receive content metadata 24 corresponding to the video assets published by the content creators. Some embodiments provide that the content locations 22 and the metadata 24 are downloadable from the Internet and/or one or more other networks or network nodes via one or more communication networks or systems. In some embodiments, the content metadata 24 includes menus that point to and/or provide links to video assets. The menus may be published by arbitrary third parties and may refer to video assets via their associated metadata. Menus may be published by content creators, publishing houses, blogs, social media and/or network attached storage (NAS) on a customer local area network (LAN).

Data from the content management module may be used by a catalog generation module 14 that may be a component of a service provider back office 10. The catalog generation module 14 may generate catalog content that may be provide to a user device 80 via a service provider system 70. For example, menu and/or content data may be ingested as requested by a request from a VOD customer. The menus and/or content may be filtered for compatibility content, such as, whether the content is free or billable.

In some embodiments, the menus and/or other catalog content may be requested by a user via a user device 80. For example, the catalog content may include interactive menus that may be provided from the catalog generation module 14 to a user device 80 via a service provider system 70.

Some embodiments provide that the content metadata 24 may include billing data corresponding to the video assets. The billing data may be specific to different ones of the content providers and may include a billing amount and payment processing data corresponding to each of the video assets. For example, billing data may include an access and/or purchase fee, method of payment, and/or digital rights terms corresponding to a purchase. Method of payment may define who to pay and how to automatically submit payment for a corresponding video asset. Some embodiments provide that assets that do not include this metadata or include metadata that is silent regarding approved payment partners, agents and/or recipients may not be candidates for inclusion in the VOD menus.

By relieving a service provider of the burden of negotiating content deals with multiple different content owners or providers, the publication and distribution of VOD media may be provided more quickly than using conventional techniques. For example, any content provider that publishes an asset with compatible metadata can be included in VOD menus. As such, available VOD content may be expanded to users, thus increasing revenue opportunities to service providers. In some embodiments, the menus are selected by the user which provides a filtering effect regarding content that matches the user's viewing tastes.

The content enhancement module 100 may include an access management module 120 that receives content metadata from the content management module 110 and that determines content purchase data therefrom. In some embodiments, the access management module 120 may function as an operator content and billing clearing house. For example, the access management module 120 may communicate with a billing module 16 in the service provider back office 10 regarding a content purchase and/or transaction. Additionally, based on a content purchase, the access management module 120 may request and/or receive content provider decryption data 28. In some embodiments, the access management module 120 may send payment to a content provider along with a request for decryption data 28 and/or in response to receiving decryption data 28. Decryption data 28 may include a link to a network location that includes a decryption key corresponding to requested video asset and/or actual decryption data and/or keys.

In some embodiments, the content management module 110 may transmit and/or a content management system 40 may receive the content locations 22 and/or data related thereto. The access management module 120 may verify content purchase data and then provide the content management system 40 with access to decryption data corresponding to a requested video asset. The content management system 40 may retrieve the video content 26 from a location corresponding to the content locations 22 and transcode the requested video asset using the decryption data from the access management module 120.

An operator encryption module 50 may receive the transcoded content from the content management system 40 and encryption keys from a content access support module 12 in the service provider back office 10 and encrypt the video asset. In some embodiments, the content access support module 12 may provide digital rights management support services corresponding to the video assets. The encrypted video asset may be transmitted to a VOD server 60, which may transmit a video stream that includes the encrypted video asset to the service provider system 70.

The service provider system 70 may receive decryption keys from the content access support 12 in the service provider back office 10 to decrypt the video stream received from the VOD server 70. In some embodiments, the user device 80 may receive the decrypted video stream from the service provider system. Some embodiments provide that the service provider system 70 may transmit the encrypted video stream and the decryption keys to the user device 80 such that the decryption of the video stream may be performed by the user device 80 as the video stream packets arrive.

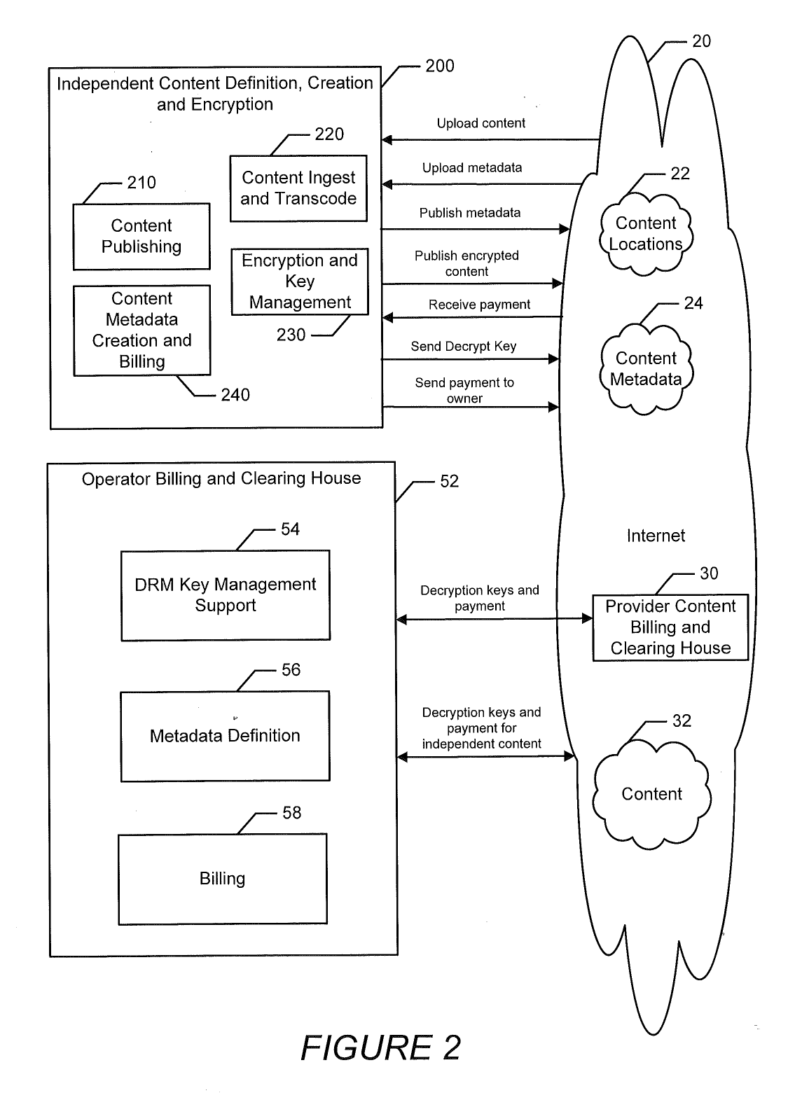

Reference is now made to FIG. 2, which is a block diagram of network devices, nodes, modules and/or operations corresponding to systems, methods and/or devices for providing content on demand according to some embodiments of the present invention. A content enhancement module 200 be operable to provide independent content definition, creation and encryption for independent content providers, such as, for example, OTT content. According to some embodiments, the content enhancement module 200 may include a content ingest and transcode module 220 that is operable to upload content and/or content locations 22 corresponding to video assets published by content providers. In some embodiments, the content locations may include menu fetch locations corresponding to the video assets.

A content metadata creation and billing module 240 may upload content metadata 24 corresponding to the video assets published by the content creators. Some embodiments provide that the content locations 22 and the content metadata 24 are downloadable from the Internet 20 and/or one or more other networks or network nodes via one or more communication networks and/or systems. In some embodiments, the content metadata 24 includes menus that point to and/or provide links to video assets. The menus may be published by arbitrary third parties and may refer to video assets via their associated metadata.

The content enhancement module 200 may publish metadata that corresponds to the uploaded content to the Internet and/or other networks or repositories in data communication therewith using a content publishing module 210. Some embodiments provide that the metadata 24 may include billing data corresponding to the uploaded content. The billing data may be specific to different ones of the content providers and may include a billing amount and payment processing data corresponding to each of the video assets. For example, billing data may include an access and/or purchase fee, method of payment, and/or digital rights terms corresponding to a purchase. Method of payment may define who to pay and how to automatically submit payment for a corresponding video asset.

An encryption and key management module 230 in the content enhancement module 200 may encrypt the uploaded content and the encrypted content may then be published via the content publishing module 210. Payment may be received from a user corresponding to content that the user intends to purchase. In some embodiments, the user provides payment via a link or other data that is included in the content metadata 24.

Once the payment is received, the encryption and key management module 230 may cause the decryption key or other decryption data corresponding to the purchased content to be sent to the user. In some embodiments, a payment may be sent to the content owner or provider. In this manner, independent content providers may be able to deliver their content through a VOD system and receive payment for their content.

Some embodiments provide that an operator billing and clearing house 52 may interface directly with a provider content billing and clearing house 30 by exchanging decryption keys and payment therebetween. For example the operator billing and clearing house 52 may provide a payment bridge between a VOD provider and a content provider. The operator billing and clearing house 52 may include digital rights management (DRM) key management support 54 to provide encryption of the content 32 that is received from a provider and then dissemination of decryption keys to authorized users. In some embodiments, the DRM key management support 54 may receive and maintain the decryption keys for later provision to users or VOD providers. Additionally, a metadata definition module 56 may generate metadata corresponding to the content 32 to a VOD provider. The VOD provider can then provide a content catalog that includes the metadata to users. In this manner, the users may become aware of and be able to select from a significant variety of content 32.

Additionally, the billing module 58 may provide payment to the provider content billing and clearing house 30 and receive payment from a VOD provider and/or a user thereof. In this manner, all content 32 published by a provider content billing and clearing house 30 may be available for purchase without additional negotiations by the VOD provider.

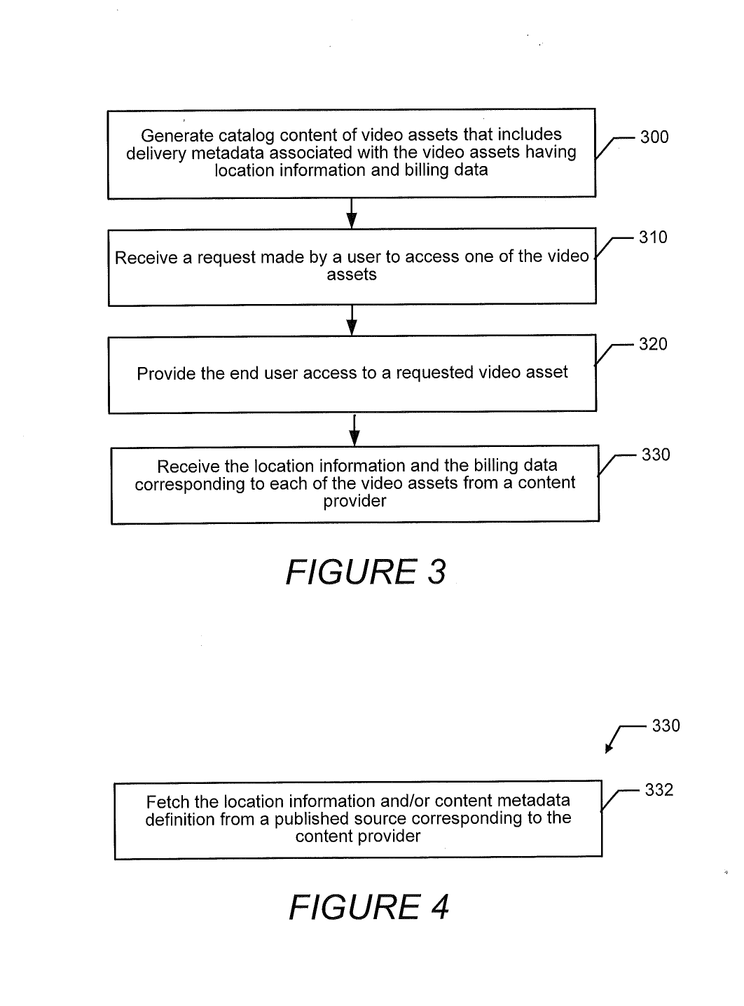

FIGS. 3-11 are flow charts of operations and methods that can be performed to provide content on demand according to some embodiments of the present invention. Referring to FIG. 3, catalog content of video assets may be generated (block 300). The video assets may be provided by multiple different content providers that may publish data that is associated with ones of the different video assets. Some embodiments provide that the catalog content of video assets is delivered to an end user by a service provider that includes at least one of a cable based content provider, an internet television service provider or an over the top content provider.

In some embodiments, the catalog content may include delivery metadata that is associated with the video assets. For example, the metadata may include billing data corresponding to different ones of the video assets. In some embodiments, the billing data may be specific to different ones of the content providers.

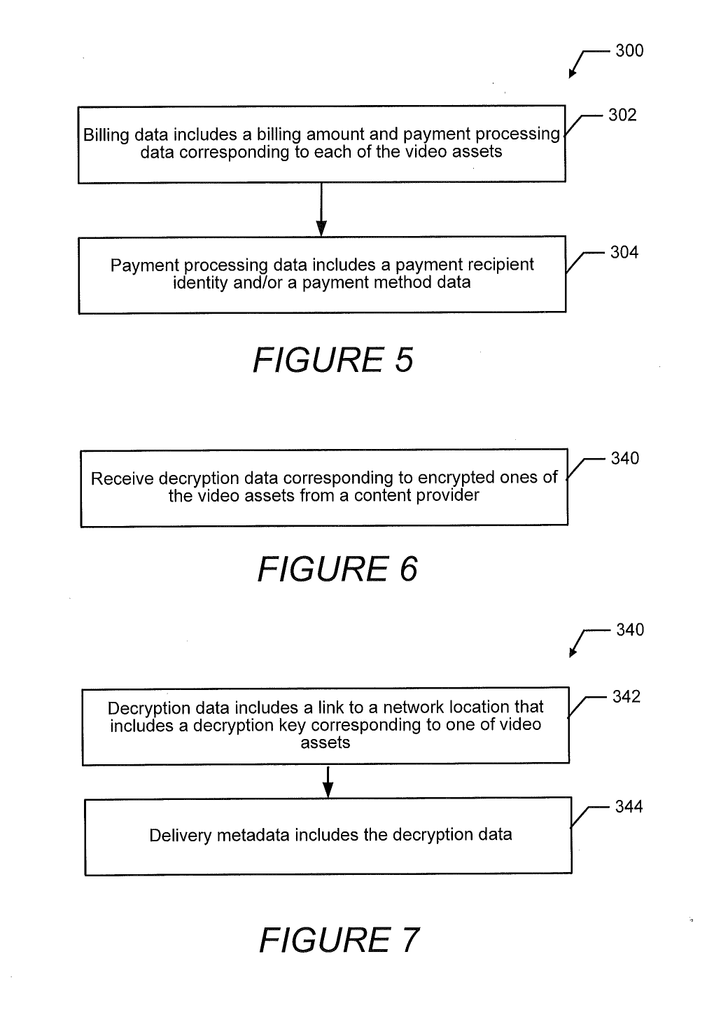

Briefly referring to FIG. 5, which is a block diagram illustrating operations corresponding to generating the catalog content, billing data may include a billing amount and payment processing data corresponding to each of the video assets (block 302). For example, billing data may include an access and/or purchase fee, method of payment, and/or digital rights terms corresponding to a purchase. In some embodiments, digital rights terms may define an access or usage time period during which a purchaser may view and/or access a video or a maximum quantity of times that a purchased video asset may be viewed. Additionally, payment processing data may include a payment recipient identity and/or payment method data (block 304).

Referring back to FIG. 3, some embodiments provide that the delivery metadata includes location information corresponding to a storage location of each of the different ones of the video assets (block 300). For example, location information may include network file storage paths, file identification information and/or Internet address identifiers, among others.

A request made by a user to access one of the video assets may be received (block 310). A request may be made by a user through any of a variety of user devices as described above. In some embodiments, the request may be made by selecting an active link, which then causes the request to be sent. The request may be received in a service provider back office and/or a third party representative or agent thereof via one or more components in a service provider system.

Access to the requested video asset may be provided (block 320). In some embodiments access may include providing the user with file location information so the user can access the requested video asset. Some embodiments provide that providing the requested video asset includes retrieving the video asset from the location and delivering the video asset via one or more systems and/or servers. For example, a content management system may provide the video asset via one or more VOD servers and/or a service provider system to a user device. In some embodiments, the user device may include a wireless and/or wired terminal that receives streaming content of the video asset.

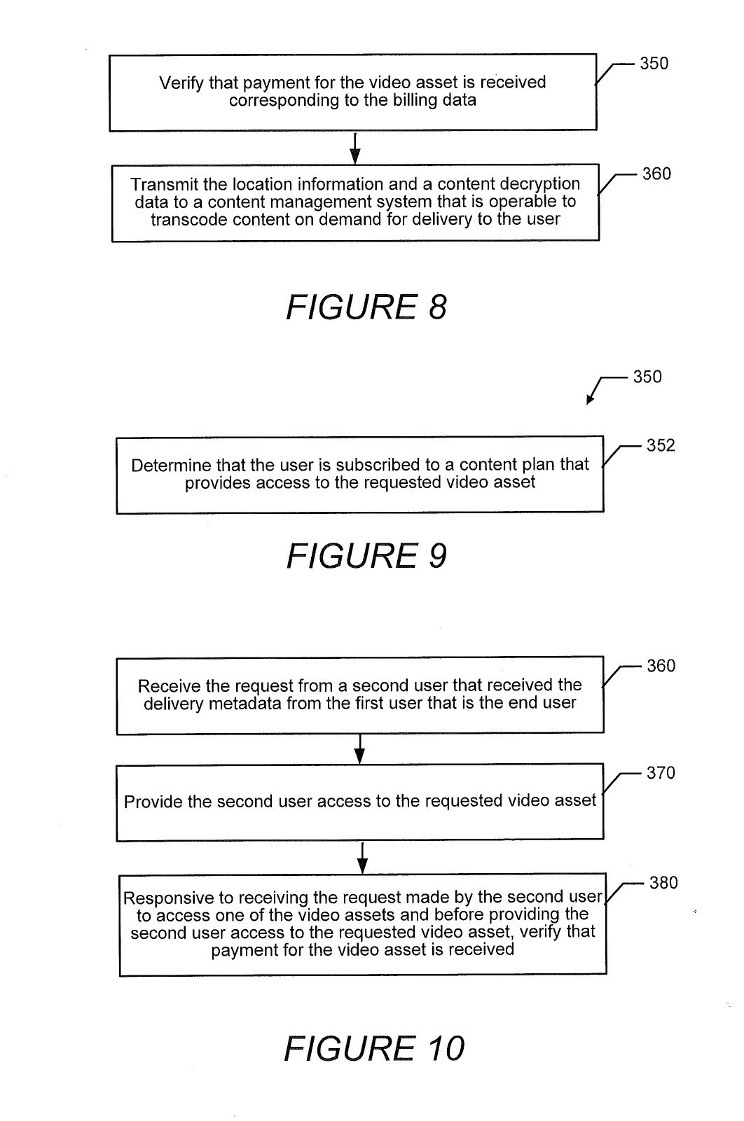

Brief reference is made to FIG. 8, which is a block diagram illustrating operations for providing content on demand according to some embodiments of the present invention. Some embodiments provide that in response to receiving a request and before an end user is provided access to a video asset, verification that a payment for the video asset is received (block 350). The payment may typically correspond to the billing data that may be included in the metadata. In some embodiments, an end user may be a subscriber to a content plan that includes the video asset. As such, briefly referring to FIG. 9, verifying the payment (block 350) may include determining that the user is subscribed to a content plan that provides access to the requested video asset (block 352).

Referring again to FIG. 8, once receipt of the payment is verified, the location information and/or content decryption data may be transmitted to a content management system that is operable to transcode the video asset for delivery to the user (block 360). In some embodiments, the content management system may be transcoding the video asset as VOD that is either encrypted or unencrypted. An operator may further encrypt the video asset before the content is sent to a VOD server. In the case of encrypted content, subsequent encryption may not be necessary. Additionally, a service provider system may include and/or work in conjunction with an access management module that receives decryption data for video assets that are encrypted by the content provider.

Referring again to FIG. 3, some embodiments provide that the location information and/or the billing data corresponding to the video assets may be received from one or more content providers (block 330). For example, metadata published by different content providers may be received and included in the catalog content of video assets. Referring briefly to FIG. 4, receiving the location information and the billing data may include fetching the location information and/or content metadata definitions from a published source that correspond to the content provider (block 332). In this manner, a variety of different content providers including traditional content providers such as particular networks and OTT providers such as independent content creators and/or repositories.

Brief reference is made to FIG. 6, which is a block diagram illustrating operations for providing content on demand according to some embodiments of the present invention. Decryption data corresponding to encrypted video assets may be received from a content provider and/or an agent or representative thereof (block 340). Some embodiments provide that encoded video is encrypted for non-free media. For example, a service provider may be given access to decryption data, such as, for example, decryption keys, that are needed to decrypt the video for transcoding and viewing. Briefly referring to FIG. 7, some embodiments provide that the decryption data may include a link to a network location that includes a decryption key corresponding to requested video asset (block 342). In some embodiments, the delivery metadata includes the actual decryption data (block 344).

In some embodiments, the video assets may include OTT content. In such embodiments, providing the end user with access to the requested video asset may include providing the delivery metadata corresponding to the requested video asset to the user to access and providing decryption data corresponding to the requested video asset. In this manner, the end user may directly access and retrieve the video asset via one or more computer and/or communication networks.

Some embodiments provide that the catalog content of video assets is delivered to an end user by a service provider that includes at least one of a cable based content provider, an internet television service provider or an over the top content provider.

Some embodiments provide that metadata corresponding to video assets may be shared among users. For example, a first user may be an end user having requested and obtained access to a video asset. A second user having interest in the video asset that is accessed by the first user may receive the delivery metadata corresponding to the video asset from the first user. Briefly referring to FIG. 10, a request to access the video asset may be received from the second user that received the delivery metadata from the first user (block 360). In such embodiments, the video asset may be made available outside the menu or content catalog provisions of the service provider. In response to receiving the request made by the second user, a verification of receipt of payment for the video asset may be verified (block 380). The second user may then be provided access to the video asset (block 370).

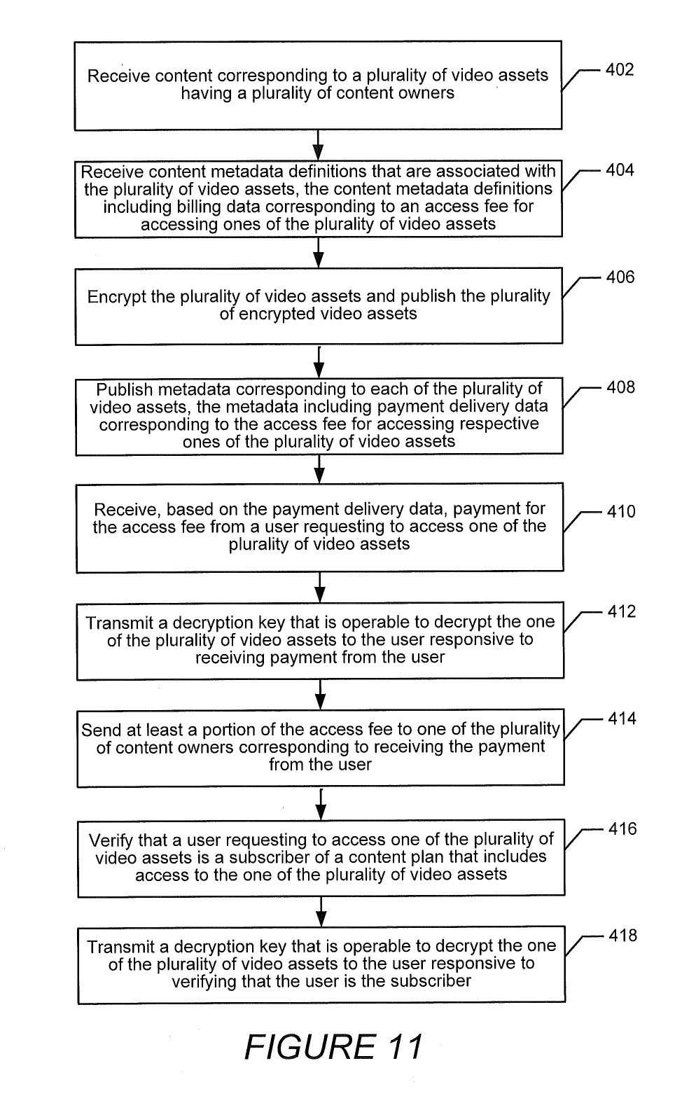

Reference is now made to FIG. 11, which is a block diagram illustrating operations for providing content on demand according to some embodiments of the present invention. Content corresponding to multiple video assets having multiple content owners may be received (block 402). For example, multiple different content providers may each provide one or more different video assets. In some embodiments, the content owners may include content creators, content clearing houses and/or content aggregators, among others. The content may be received directly from the content owners or via a link and/or identifier corresponding to a data repository.

Content metadata definitions that are associated with the video assets may be received (block 404). The content metadata definitions may include billing data corresponding to an access fee for accessing ones of the video assets. The video assets may be encrypted and then published as encrypted video assets (block 406). In this manner, the video assets may be published for non-free media. Some embodiments provide that metadata corresponding to the video assets may be published (block 408). The metadata may include payment delivery data for accessing video assets. For example, the delivery data may include information corresponding to an access fee, payment methods, and/or identification of payment recipients, among others. In some embodiments, the delivery data may identify one or more subscriber plans under which an access fee for a video asset is waived and/or satisfied.

A payment for the access fee may be received from a user requesting access to a video asset (block 410). In some embodiments, the payment may be received by a service provider, VOD provider, and/or a representative and/or agent thereof. A decryption key that is operable to decrypt the requested video asset may be transmitted to the user responsive to receiving payment from the user (block 412). In some embodiments, the actual decryption key may be transmitted. Some embodiments provide that a link to decryption key data and/or a network address thereof may be transmitted. In some embodiments, the decryption key and/or decryption key data may be transmitted to a service provider on behalf of the user to decrypt the content before transmitting the content to the user. In some embodiments, the decryption key and/or decryption data may be transmitted to the user and to decrypt the content upon receiving the decrypted content.

Some embodiments include sending at least a portion of the access fee to a content owner corresponding to receiving the payment from the user (block 414). For example, a portion of the access fee may be retained by a service provider as compensation for delivering content and/or metadata and/or publishing the video asset as a menu selection. In some embodiments, the service provider may receive a flat fee for each purchase of a video asset, whereas some embodiments provide that the service provider receives a percentage of the fee collected.

Instead of providing a payment for a specific video asset requested, a user may subscribe to a content plan that includes access to the video asset without any additional payment. In such embodiments, it may be verified that a user requesting access to a video asset is a subscriber to a content plan that includes access to the requested video asset (block 416). In response to verifying that the user is a subscriber to a content plan that includes the requested video asset, a decryption key that is operable to decrypt the requested video asset may be transmitted to the user (block 418).

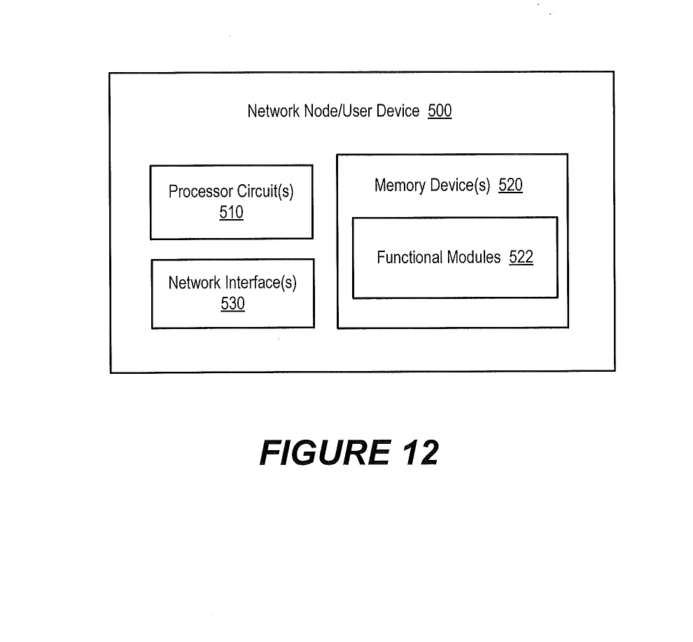

Reference is now made to FIG. 12, which is a block diagram of a network node/user device configured according to some embodiments of the present invention. The network node/user device 500 includes a processor circuit 510, memory circuitry/devices 520, and one or more network interfaces 530. The one or more network interfaces 530 can include any type of wired and/or wireless communication interface (e.g., cellular, wireless local area network, wireless metropolitan area network, etc.).

The processor circuit 510 may include one or more data processing circuits, such as a general purpose and/or special purpose processor (e.g., microprocessor and/or digital signal processor). The processor circuit 510 is configured to execute computer program instructions from functional modules 522 in the memory devices 520, described below as a computer readable medium, to perform some or all of the operations and methods that are described above for one or more of the embodiments disclosed herein, such as the embodiments of FIGS. 1-11.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the invention. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention. Accordingly, the above disclosed subject matter is to be considered illustrative, and not restrictive, and the appended claims are intended to cover all such modifications, enhancements, and other embodiments, which fall within the spirit and scope of the present invention. Thus, to the maximum extent allowed by law, the scope of the present invention is to be determined by the broadest permissible interpretation of the following claims and their equivalents, and shall not be restricted or limited by the foregoing detailed description. Any reference numbers in the claims are provided only to identify examples of elements and/or operations from embodiments of the figures/specification without limiting the claims to any particular elements, operations, and/or embodiments of any such reference numbers.

1. A method by at least one network node of providing content on demand, the method comprising:
generating catalog content of video assets that includes delivery metadata associated with the video assets and that is published by a plurality of content providers, the delivery metadata including location information corresponding to a storage location of each of the video assets and billing data that is associated with each of the video assets and that is specific to a respective one of the plurality of content providers;
receiving a request made by a user to access one of the video assets; and
providing the user access to a requested video asset.

2. The method according to claim 1, further comprising receiving the location information and the billing data corresponding to each of the video assets from an associated one of the plurality of content providers.

3. The method according to claim 2, wherein receiving the location information and/or the billing data comprises fetching the location information and/or content metadata definition from a published source corresponding to at least one of the plurality of content providers.

4. The method according to claim 1, wherein the billing data includes a billing amount and payment processing data corresponding to each of the video assets.

5. The method according to claim 4, wherein the payment processing data includes a payment recipient identity and/or a payment method data.

6. The method according to claim 1, further comprising receiving decryption data corresponding to encrypted ones of the video assets from ones of the plurality of content providers.

7. The method according to claim 6, wherein the decryption data includes a link to a network location that includes a decryption key corresponding to one of video assets.

8. The method according to claim 6, wherein the delivery metadata includes the decryption data that corresponds to encrypted ones of the video assets.

9. The method according to claim 1, wherein responsive to receiving the request made by a user to access one of the video assets and before providing the user access to the requested video asset, further comprising:
verifying that payment for the video asset is received corresponding to the billing data; and
transmitting the location information and content decryption data to a content management system that is operable to transcode content on demand for delivery to the user.

10. The method according to claim 9, wherein verifying that the payment for the video asset is received comprises determining that the user is subscribed to a content plan that provides access to the requested video asset.

11. The method according to claim 1,
wherein the video assets comprise over the top content, and
wherein providing the user access to the requested video asset comprises:
providing the delivery metadata corresponding to the requested video asset to the user to access; and
providing decryption data corresponding to the requested video asset.

12. The method according to claim 1, wherein the catalog content of video assets is delivered to an end user by a service provider that includes at least one of a cable based content provider, an internet television service provider or an over the top content provider.

13. The method according to claim 1,
wherein the end user comprises a first user,
wherein receiving the request to access one of the video assets comprises receiving the request from a second user that received the delivery metadata from the first user,
wherein providing the end user access to the requested video asset comprises providing the second user access to the requested video asset, and
wherein responsive to receiving the request made by the second user to access one of the video assets and before providing the second user access to the requested video asset, the method further comprising verifying that payment for the video asset is received corresponding to the billing data.

14. A method by at least one network node of providing content on demand, the method comprising:
receiving content corresponding to a plurality of video assets having a plurality of content owners;
receiving content metadata definitions that are associated with the plurality of video assets, the content metadata definitions including billing data corresponding to an access fee for accessing ones of the plurality of video assets;
encrypting the plurality of video assets and publishing the plurality of encrypted video assets; and
publishing metadata corresponding to each of the plurality of video assets, the metadata including payment delivery data corresponding to the access fee for accessing respective ones of the plurality of video assets.

15. The method according to claim 14, further comprising:
receiving, based on the payment delivery data, payment for the access fee from a user requesting to access one of the plurality of video assets; and
transmitting a decryption key that is operable to decrypt the one of the plurality of video assets to the user responsive to receiving payment from the user.

16. The method according to claim 15, further comprising sending at least a portion of the access fee to one of the plurality of content owners corresponding to receiving the payment from the user.

17. The method according to claim 14, further comprising:
verifying that a user requesting to access one of the plurality of video assets is a subscriber of a content plan that includes access to the one of the plurality of video assets; and
transmitting a decryption key that is operable to decrypt the one of the plurality of video assets to the user responsive to verifying that the user is the subscriber.

18. A computer implemented system for providing content on demand, the system comprising:
a content management module that is operable to receive menu fetch locations corresponding to video assets published by content providers and content metadata that includes billing data corresponding to the video assets and to generate catalog data including the menu fetch locations and/or the content metadata; and
an access management module that is operable to receive decryption data corresponding to the video assets and to determine content purchase data from the content metadata received by the content management module.

19. The system according to claim 18,
wherein the content management module is further operable to transmit content fetch location data to a content management system, and
wherein the access management module is further operable to verify content purchase data and to provide the content management system access to decryption data corresponding to a requested video asset.

20. The system according to claim 19, wherein the content management system is operable to retrieve the video content from a location corresponding to the content fetch location data and to transcode the requested video asset using the decryption data from the access management module.
